(19) United States
(12) Patent Application Publication
(10) Pub. No.: US 2008/0130207 A1
(43) Pub. Date: Jun. 5, 2008

(54) USB connector assembly

(75) Inventor: Robert M. Schmidt, Livonia, MI (US)

Correspondence Address: SEYFARTH SHAW LLP, 131 S. DEARBORN ST., SUITE 2400, CHICAGO, IL, 60603-5803, US

(73) Assignee: Methode Electronics, Inc.

(21) Appl. No.: 11/999,433

(22) Filed: Dec. 5, 2007

Related U.S. Application Data
(60) Provisional application No. 60/873,166, filed on Dec. 5, 2006.

(51) Int. Cl. G06F 1/16

(52) U.S. Cl. 361/679

(57) ABSTRACT

A universal serial bus receptacle for receiving a universal serial bus plug is disclosed. The receptacle utilizes an inner casing similar to a typical universal serial bus receptacle and an outer casing mounted around the inner casing to provide supporting structure to resist vibrational or other forces so that vibrational movement of the plug within the receptacle is reduced or prevented. This serves to reduce wear between the contact leads of the receptacle and the plug, making the receptacle suitable for long-term installation in a high-vibration environment such as an automobile. The supporting structure is preferably a pair of dual-leaf springs mounted on both side of the receptacle to provide a counter-balance to any tilting or deflection by the plug when received in the receptacle, the dual-leaf springs contact the plug in both fore and aft positions on both sides of the plug.

### CROSS-REFERENCE TO RELATED APPLICATION(S)

This application claims the benefit of U.S. Provisional Application No. 60/873,166, filed Dec. 5, 2006.

### FIELD OF THE INVENTION

The invention relates to connectors for universal serial bus (USB) plugs and, in particular, to a USB assembly that reduces vibration effects on the electrical connections between a USB plug and a USB receptacle.

### BACKGROUND

Universal serial bus (USB) devices are defined by a standard including both a USB plug and a USB receptacle for receiving and electrically connecting with the USB plug. There are many designs for USB devices, as the standard is focused on a relatively narrow set of aspects of the devices. Specifically, the standard provides that certain aspects are required, such as the position of contact leads, a signal name for the contacts, contact wiring assignments, and some of the dimensional aspects of the devices, while others are references that may vary from manufacturer to manufacturer.

Outside of mating geometry between the plug and the receptacle connection cases and lead positions, the dimensional aspects of the standards are somewhat open-ended. Generally speaking, the USB connection and devices provide an easy to use yet robust device. The USB devices provide a slip-fit connection that is easier to use and less fragile than, for instance, a pin connection. In fact, the use of the USB devices is facilitated by loose tolerances and fit between the plug and the receptacle. The loose tolerances are compensated for by using biased cantilever receptacle contacts, and using biased cantilever arms received in side openings of the plug to retain the plug in the receptacle.

In greater detail, the USB plug is received in the USB receptacle rather easily, the entry of the plug deflecting biased cantilevers of the receptacle outwardly to permit receipt of the plug therein. The plug terminal or connecting end has a rectangular sheath or casing, with major and minor dimensions, defining an interior with a base or substrate having a first side in abutment with an interior surface of the sheath and a second, opposite side adjacent a generally empty cavity within the sheath. The second side of the substrate includes plug contacts or leads thereon facing into the cavity. Both the substrate and cavity are generally oriented, or aligned, with the major dimension of the sheath.

The plug is inserted into a similarly rectangularly shaped sheath of the receptacle. The receptacle sheath defines an interior cavity that, according to the standard, is toleranced to be 0.41 mm to 0.21 mm larger than the plug sheath in the direction of the minor dimension, and is toleranced to permit a maximum of 0.7 mm larger in the major dimension direction.

The relatively large dimensional differences between the plug and the receptacle allow for easy insertion, and retention structure is provided to assist in maintaining the plug and receptacle in a proper electrically connected relationship. As defined by the standard, the plug sheath includes four openings, two of which are each located on the major dimensional sides of the sheath. Cooperating with these openings are spring cantilever retainers extending inwardly into the interior of the receptacle, the cantilevers having a chamfered or angled end so that entry of the plug sheath deflects the cantilevers outward until an elbow formed at the base of the chamfer aligns with and is biased into the plug sheath openings. The spring bias of the cantilevers serve somewhat to hold the plug therebetween, and the cantilevers and plug sheath also provide a ground or shield/drain wire for the plug and receptacle.

The relatively light constraint provided by the cantilevers generally presents few issues for most USB applications. The receptacle leads, as noted above, are cantilevered like the retention cantilevers, and the receptacle leads are also formed with a elbow leading to an angled ramp end or chamfer. As the plug enters the receptacle, the substrate deflects the ramp end of the receptacle leads outward, and the bias of the receptacle leads forces the elbow into contact with the substrate and the plug leads thereon.

For most USB applications, the only connection issue between the plug and the receptacle is wear between the receptacle leads and the plug leads. More specifically, insertion and removal of the plug from the receptacle results in wear between the elbow of the receptacle leads and the plug leads. These leads are generally plated to improve electrical conductivity with gold, for instance, but have an underlying base metal that is much more susceptible to oxidation. What occurs, therefore, is known as fretting corrosion where the oxidation-resistant plating material wears away to expose a base that is, comparatively speaking, oxidation-prone. In respect to this possibility, the USB standard requires a minimum of 1500 plug insertions. When using USB devices with, for instance, a generally stationary computer or the like, such a minimum is likely adequate.

However, for certain applications the wear resistance for a standard USB connection is not sufficient. As an example, one of the applications seeking to accommodate the immense popularity in music-playing devices such as MP3 players is providing in-dash connectivity with vehicles such as automobiles. In the past, automobile connectivity with portable music devices relied on a cassette-tape deck and on a device for connecting a line-out port on the music device (such as a portable CD-player or an MP3 player) with the cassette deck. However, cassettes have already become outmoded, and it appears as though compact discs are well on their way to being supplanted by non-tangible purchase means such as downloading music. The automobile industry realizes that, eventually, there will be greater demand for connecting a portable music device directing into an automobile for playing music than for inserting record-industry manufactured and distributed CDs and cassettes.

Use of USB connectors in an automobile presents at least one very specific issue: vibration. Vibration of a dashboard in an automobile comes from many things, including road conditions, the running of the vehicle motor and other under-the-hood components, and the mating of brake components. Passengers in a vehicle are usually aware of vibration only when the amount seems out of the ordinary, but one need only watch the surface of liquid of a drink in a cup-holder to recognize the vibrational effects coursing through the vehicle.

For the USB connection, it should be realized that the terminal end is only received in the receptacle by less than 1 cm. For a series “A” plug (for a commonly-carried USB “drive”), the entire plug is generally over 6 cm, while a series “B” plug is upwards of 3 cm and includes a cable or cord extending therefrom for connection to a portable device. The result of this is that the plug body (as well as any cable connected thereto) produces a moment force around the connection ends, and the plug bounces in response to automobile vibration.

While this bounce is generally not significant enough for a vehicular passenger to even notice, it has significant effects on the connection leads between the plug and the receptacle. First of all, were the vibration significant enough that the leads were to actually come out of contact during data transmission, the control processors for the automobile audio system or the device connected with the receptacle may register an error (the interruption being interpreted as device removal), and/or music being played may skip, for instance. While these are generally nuisances or minor performance problems, a greater concern is the leads themselves.

The leads, as discussed above, include the receptacle leads having an elbow biased into the plug leads. As the plug bounces due to vibration, there is constant wear on the elbow surface and the corresponding contact area on the plug leads. As the standard for USB connections requires only 1500 insertions, discussed above, the plating on the leads is generally insufficient to withstand such wear. The result is the above-discussed fretting corrosion where the underlying base metal oxidizes, preventing or inhibiting signal current. Eventually, the in-dash receptacle may become useless, and opening the dashboard to repair/replace such receptacle would be time consuming and laborious. While one may simply select metals for the base of the leads that are more robust or less prone to oxidation such as gold or stainless steel, such solutions may dramatically increase the cost of using the USB devices.

Another issue attendant to the vibration is the fragility of solder connections. The USB receptacle is generally mounted on a printed circuit board (PCB). As the plug body bounces within the receptacle, this bouncing is at least partially transmitted through to the solder connections between the receptacle and the PCB. As is well-known, solder connections are poor under cyclic stress. Accordingly, the bouncing of the plug results in repeated stress at the solder joints and, hence, breaks the electrical connections between the receptacle and the PCB.

Accordingly, there has been a need for an improved connection between USB plugs and receptacles for applications, particularly those which experience vibrational forces.

### SUMMARY

In accordance with an aspect, a universal serial bus receptacle is disclosed including a supporting structure for contacting a universal serial bus plug when received therein, the supporting structure providing bias to oppose deflection of the plug within the receptacle.

In some forms, the supporting structure includes a plurality of bias structures that cooperate to balance force applied by each bias structure against the plug within the receptacle. The supporting structure may include a first bias structure and a second bias structure, each of the first and second bias structures providing respective forces in opposite directions. The first bias structure may provide a force around a pivot point in a first direction, while the second bias structure may provide a force around the pivot point in a second direction opposite the first direction. The first and second bias structures may be formed integral as a dual-leaf spring.

In some forms, when the plug is received within the receptacle, the first bias structure contacts the plug in an aft position, and a second bias structure contacts the plug in a fore position. The supporting structure may further include a third bias structure for contacting the plug in a second aft position, and a fourth bias structure for contacting the plug in a second fore position, wherein the bias structures dynamically balance the sum of forces therefrom around the pivot point. The bias structures may be formed as a pair of dual-leaf springs.

In some forms, the receptacle may further include an inner casing for receiving the plug therein, the inner casing may include a set of openings for the supporting structure, the supporting structure may include at least two bias structures providing forces in opposite directions to oppose deflection of the plug received within the inner casing, and the bias structures may at least partially pass through the inner casing openings to contact the plug received therewithin. The set of openings may include first and second aft openings in opposed sides of the inner casing, and first and second fore openings in the opposed sides of the inner casing, each of the fore and aft openings receiving bias structure to permit the bias structures to contact the plug when received within the inner casing. The receptacle may further include an outer casing for mounting and positioning the bias structures with at least a portion of the bias structures extending through the inner casing openings to contact and provide bias to the plug when received therein. The bias structures may provide a counter-balanced force with respect to each other against the plug when received therein.

In some forms, the receptacle may further include cantilever retaining arms having at least a portion receivable within plug openings to assist in retaining the plug in the receptacle, wherein the supporting structure includes bias structures positioned to contact and provide bias force in opposite directions around a pivot point generally defined by the retaining arms and plug openings.

In some forms, the supporting structure may include a first dual-leaf spring adapted to contact a first side of the plug when received in the receptacle in fore and aft positions, and a second dual-leaf spring adapted to contact a second side of the plug in fore and aft positions. The receptacle may further include cantilever retaining arms having at least a portion receivable within plug openings to assist in retaining the plug in the receptacle. The receptacle may further include an inner casing for receiving the plug therein, the cantilever arms formed integral with the inner casing, and an outer casing mounted around the inner casing, the outer casing providing a mount for the supporting structure. The inner casing may include openings to permit the support structure to pass at least partially therethrough to contact the plug when received within the receptacle.

In some forms, the deflection is the result of vibrational forces, and the supporting structure opposes the vibrational forces. The receptacle may be mountable in an automobile, and the supporting structure opposes vibrational forces due to operation of the automobile.

In some forms, the receptacle further includes an inner casing for receiving the plug therein, and an outer casing maintaining the supporting structure in contact with the plug when received within the receptacle, the outer casing serving to reduce vibrational stress on solder joints between the receptacle and a structure to which the receptacle is mounted.

In some forms, the supporting structure includes bias structures adapted to contact major dimension sides of the plug, and includes bias structures for contacting minor dimension sides of the plug when received therein. The receptacle may further include an inner casing formed integral with the bias structures for contacting the minor dimension sides of the plug when received therein. The receptacle may further include cantilever retaining arms having at least a portion receivable within plug openings to assist in retaining the plug in the receptacle, wherein the retaining arms are formed integral with the inner casing and with the bias structures for contacting the minor dimension sides of the plug when received therein.

### BRIEF DESCRIPTION OF THE DRAWINGS

In the Figures, FIG. 1 is a cross-sectional view of a universal serial bus (USB) connection including a typical USB plug in accordance with USB standards such as either standard series “A” or series “B” and mated within a USB receptacle in accordance with USB standards and further having a supporting structure in contact with the USB plug when received within the USB receptacle to reduce and impede movement of the USB plug within the USB receptacle;

FIG. 2 is a cross-sectional view taken along the line 2-2 of FIG. 4 showing an inner casing of the USB receptacle of FIG. 1 and structure therein, and the USB plug of FIG. 1 received within the USB receptacle;

FIG. 3 is an elevational view of a USB receptacle of the PRIOR ART having the USB plug received therein;

FIG. 4 is an elevational view similar to FIG. 3 showing the inner casing of the USB receptacle of FIG. 2 having the USB plug received therein and having an extended length in comparison to the USB receptacle of the PRIOR ART in FIG. 3;

FIG. 5 is a second elevational view of the inner casing of FIG. 2 showing side finger-like supporting structure formed on a portion of the inner casing for contacting the USB plug when received therein to reduce or impede movement of the USB plug;

FIG. 6 is a third elevational view of the inner casing of FIG. 3 showing interior structure thereof including receptacle leads, the side finger-like supporting structure of FIG. 5, and retainers for restricting or impeding withdrawal of the USB plug from the receptacle;

FIG. 7 is an elevational view of the USB receptacle, the view similar to the view of FIG. 6 showing the outer casing secured around the inner casing of FIG. 3;

FIG. 8 is an second elevational view taken along the line 8-8 of the USB receptacle of FIG. 7 with the USB receptacle secured with a printed circuit board;

FIG. 9 is an elevational view of one halve of the outer casing of FIG. 7, the halve, in a recess thereof, supporting structure for impeding movement of the USB plug when received within the receptacle;

FIG. 10 is a second elevational view taken along the line 10-10 of FIG. 9 showing the halve having supporting structure mounted or positioned within the recess;

FIG. 11 is a cross-sectional view of the halve and supporting structure taken along the line of 11-11 of FIG. 10;

FIG. 12 is an elevational view identical to FIG. 1;

FIG. 13 is an elevational view similar to FIG. 7 showing a second form of a USB receptacle having an enlarged base portion for securing with a printed circuit board; and

FIG. 14 is an elevational view of the USB receptacle of FIG. 13 taken through the line 14-14 of FIG. 13.

### DETAILED DESCRIPTION

Referring initially to FIG. 1, a USB receptacle 10 for resisting vibration and movement of any standard USB plug 12 is depicted. Towards this end, the receptacle 10 includes an outer casing 14 positioned around an inner casing 16, the outer casing 14 including supporting structure 18 for reducing the mobility of the plug 12 within the receptacle 10. The supporting structure 18, thus, serves to reduce the movement of leads 20 of the plug 12 relative to leads 22 of the receptacle 10.

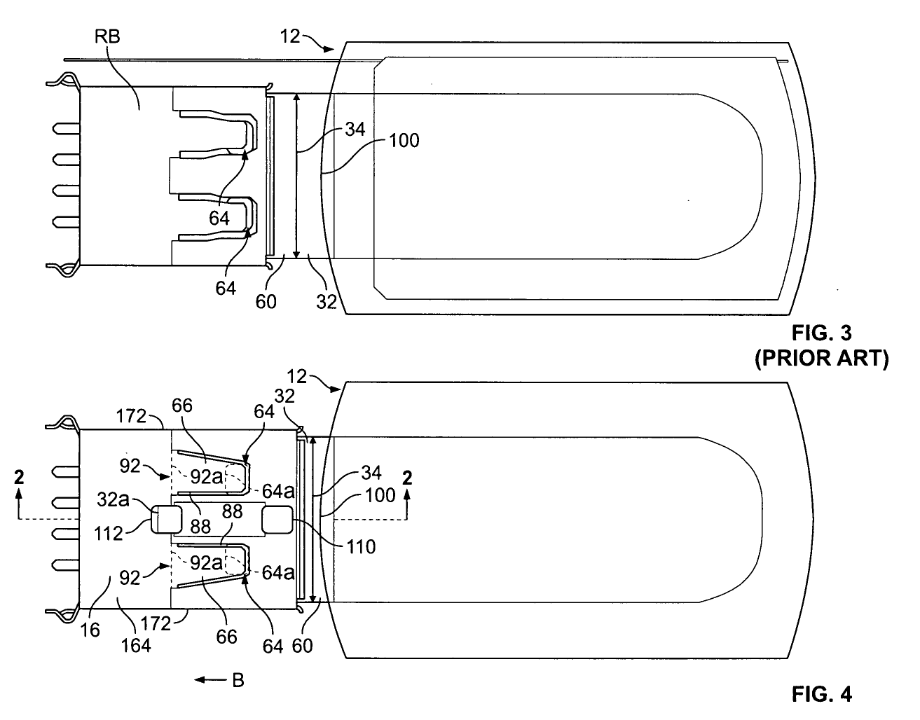

Generally speaking, the plug 12 is standardized and meets the series “A” or series “B” definitions. As described in the background, the standard plug 12 includes a terminal or connection end 30 including a generally rectangular sheath 32 having a major dimension 34 (FIGS. 3 and 4) and a minor dimension 36. Aligned with the sheath major dimension 34 and positioned to one side within the sheath 32 is a substrate 38 having a relatively small substrate minor dimension 40 aligned with the sheath minor dimension 36. The substrate 38 has a first side 42 positioned against or close to an interior surface 44 of the sheath 32, aligned with the sheath major dimension 34, so that a substrate second side 46 opposite the first side 42 thereof defines a cavity 48 between the substrate second side 46 and a second sheath interior surface 50 that is opposite the interior surface 44. Plug leads 20 are positioned on the substrate second side 46 that are accessible within the cavity 48. Generally, the substrate is a non-conductive material, the leads 20, 22 are electrically conductive and electrically communicate with each other, and the sheath 32 is in electrical communication with the inner casing 16 to provide a shield or drain wire.

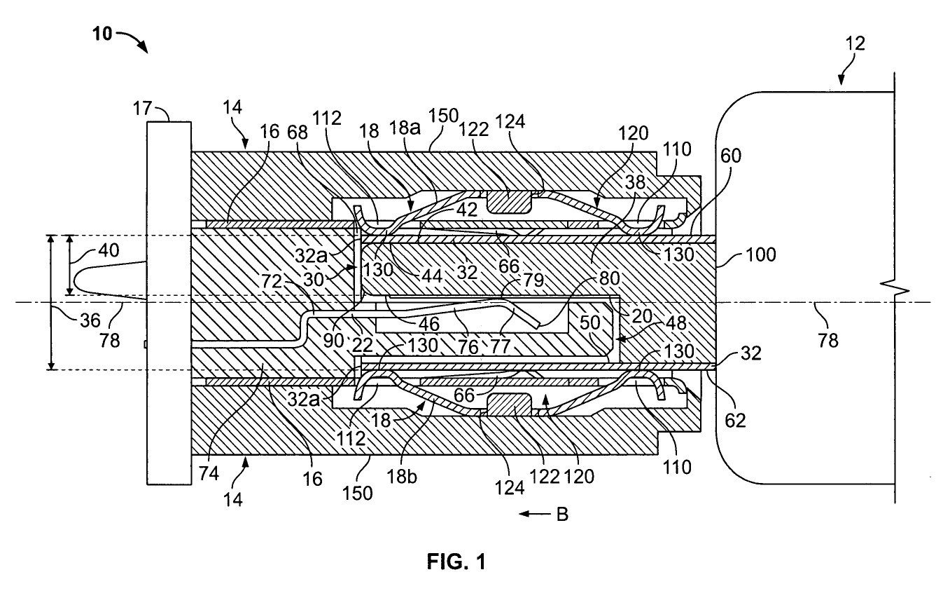

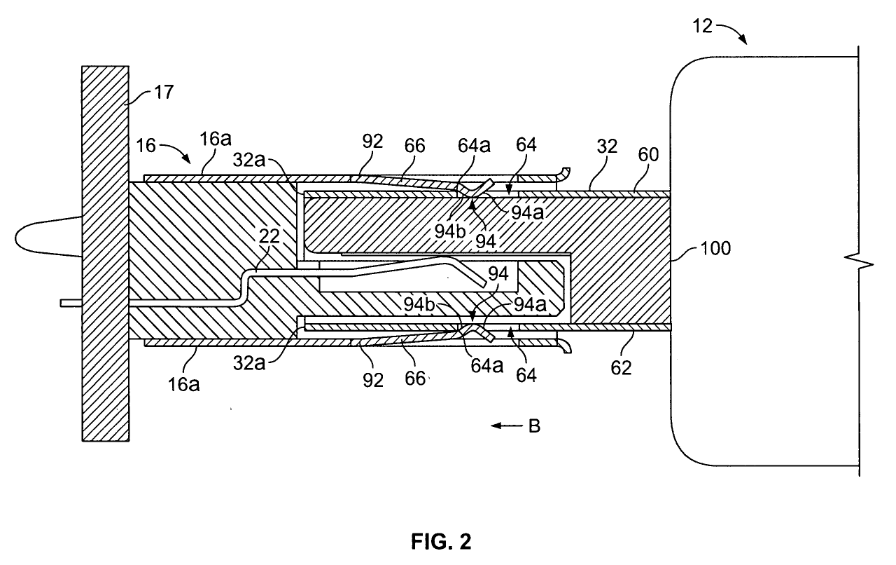

The plug sheath 32 has first and second sides 60 and 62 that respectively include the interior surfaces 44 and 50. As best seen in FIGS. 2-4, each side 60, 62 includes two openings 64, generally defined by the USB standard, for receiving leaf spring retainers 66 of the receptacle 10, as also defined by the USB standard.

The receptacle 10 is in accordance with a series “A” standard USB receptacle, for instance. Specifically, dimensional requirements of the receptacle 10 that relate to receiving the plug 12 conform to the USB standard, as do wiring protocols, etc. The principal modifications of the receptacle 10, in comparison to a common or typical USB receptacle that is also within the USB standard, the present receptacle 10 includes an outer casing 14 with the supporting structure 18, and an extended length for the receptacle 10 including the inner casing 16 which would otherwise correspond to a receptacle body RB in a prior art USB, illustrated in FIG. 3. Each of the novel modifications will be described herein.

Accordingly, the receptacle inner casing 16 and components therein need not significantly deviate from the USB standard. The inner casing 16 defines a cavity 68 (see, e.g., FIG. 6) for receiving the plug connection end 30. The receptacle 10 includes the leads 22 aligned in accordance with the USB standard to mate with and contact the plug leads 20 when the plug 12 is received within the receptacle cavity 68. The receptacle leads 22 are generally cantilevers having a base portion 72 mounted in and extending from a boot 74, a first elbow portion 76 angled inwardly towards the cavity 68 or with respect to a longitudinal axis 78 of the receptacle 10. The first elbow portion 76 is joined with a second elbow portion 77 angled outwardly with respect to the receptacle axis 78 to form a contact area 79, and the leads 22 terminate with a tip 80.

The receptacle leads 22 are mounted so that the base portion 72 is generally positioned to one side of the receptacle axis 78. As the plug sheath 32 is inserted into the receptacle inner casing 16 for electrical connection between the plug 12 and the receptacle 10, a lead edge 90 of the plug substrate 38 contacts the second elbow portions 77 of each receptacle lead 22, at a point in-board from the lead tip 80, to deflect the receptacle leads 22 outward (away from the receptacle axis 78 and towards a side of the cavity 68). The receptacle leads 22 have a natural elasticity to impart a bias force to direct the receptacle lead 22 into the substrate 38 so that the lead contact areas 79 are against the plug leads 20 for electrical communication between the leads 22, 20.

In accordance with the USB standard, the inner casing 16 includes the above-mentioned leaf spring retainers 66 received in the plug openings 64. The leaf spring retainers 66 are formed from side portions 16a of the inner casing 16, the side portions 16a being sides aligned with the major dimension 34 of the plug 12 when connected therewith, and openings 88 being cut through the inner casing side portions 16a to define the retainers 66. The resulting portion of the inner casing 16 for the retainers 66 is then shaped (such as by stamping) so that the retainers 66 are angled inwardly towards the receptacle axis 78 at a base portion 92, and so that the retainers 66 have an elbow 94 formed thereon, as can be seen in FIG. 2.

As the plug 12 is inserted into the receptacle 10, the plug sheath 32 contacts a lead side 94a on the retainer elbows 94 to deflect the elbows 94 outwardly (away from the receptacle axis 78). Once the plug 12 has been inserted to a sufficient depth or extent, the elbows 94 become aligned with and resiliently move towards their natural position so that the elbows 94 are received within the plug openings 64 with an elbow trailing side 94b contacting a forward edge 64a of the openings 64. This allows the elbows 94 to somewhat hook with and onto the plug 12 and hook onto the plug openings 64.

The purpose of the leaf spring retainers 66 in basic USB applications is to resist withdrawal of the plug 12 from the receptacle 10. Towards this end, little attention was paid to details of the leaf spring retainers 66. In an aspect of the present invention, the leaf spring retainers 66 are made more robust to resist vibrational forces. To accomplish this, the base portion 92 is widened at its connection line 92a (FIG. 4) with the inner casing 16, and the extent of the contact between the opening edge 64a with the elbow trailing side 94b is also widened. This allows for a stiffer spring bias (higher spring constant) for the retainers 66, and greater resistance to fatigue, without having to increase the angle of inward deflection for the retainers 66 relative to the inner casing 16.

It should also be noted that, for typical USB connections, leaf spring retainers generally only resist withdrawal of the plug from the receptacle. In typical USB design, with the leaf spring retainers received in the plug openings, there is still significant play. That is, the plug can manually be moved into, out of, and around within the receptacle without significant resistance from typical retainers. In the present form, tolerances are preferably controlled for the leaf spring retainers 66 and plug openings 64 so that the spring retainers 66 serve to keep the plug 10 closely drawn into the receptacle 12 approximately, though not necessarily achieving, a snap-fit.

To increase the benefit of the supporting structure 18 within the outer casing 14, the inner casing 16 is longer than that of a typical USB receptacle, a comparison being shown in FIGS. 3 and 4, though the USB standard makes the length of the inner casing 16 only a reference dimension. In the USB standard, the length of the plug sheath 32 is generously proportioned and much longer than is required to mate with a typical receptacle. That is, the length of plug sheath 32 from its leading edge 32a to its boot or housing 100 is longer than is required, as can be seen in prior art FIG. 3. Some of the reasons for this extra length are common design and mounting techniques for the standard USB receptacle which allow the receptacle to be mounted to a printed circuit board (PCB), which is in turn mounted with internal components of a device (such as a computer). A housing is then mounted over the internal components, and the extra length allows a significant inset between an opening in the housing for accessing the receptacle and the receptacle cavity for receiving the plug.

For automobile applications, as an example, the extra length afforded the plug sheath 32 between the leading edge 32a and the plug boot 100 is less necessary (compare FIGS. 3 and 4), if at all. While the receptacle 10 is intended to be mounted to a PCB 17 of an automobile, the PCB 17 itself or associated electrical components (i.e., stereo components) are mounted directly to the dashboard or cover. This is in contrast where a large amount of error (variation in PCB mounting that effects the tolerance between leading edge 32a and plug boot 100) is designed into the packaging for a computer, for instance, so that precision in mounting the receptacle with the computer housing is not important. However, in an automobile, mounting directly to the dashboard or a cover thereof, greater precision in alignment of the receptacle 10 and an opening in the dashboard or cover is provided as a matter of course. Therefore, the receptacle 10 of the present invention, in use with an automobile application, need not have as large of tolerances.

Turning to FIGS. 1 and 4, each of the inner casing 16 side portions 16a includes fore openings 110 and aft openings 112 allowing a portion of the supporting structure 18 to pass therethrough. The openings 110, 112 are generally aligned with the receptacle longitudinal axis 78 so that they are positioned along a center line of the inner casing 16 and bisecting the distance between the leaf spring retainers 66, as well as being positioned so the leaf spring retainers 66 are aligned along a line between the openings 110, 112, as can be seen in FIG. 4.

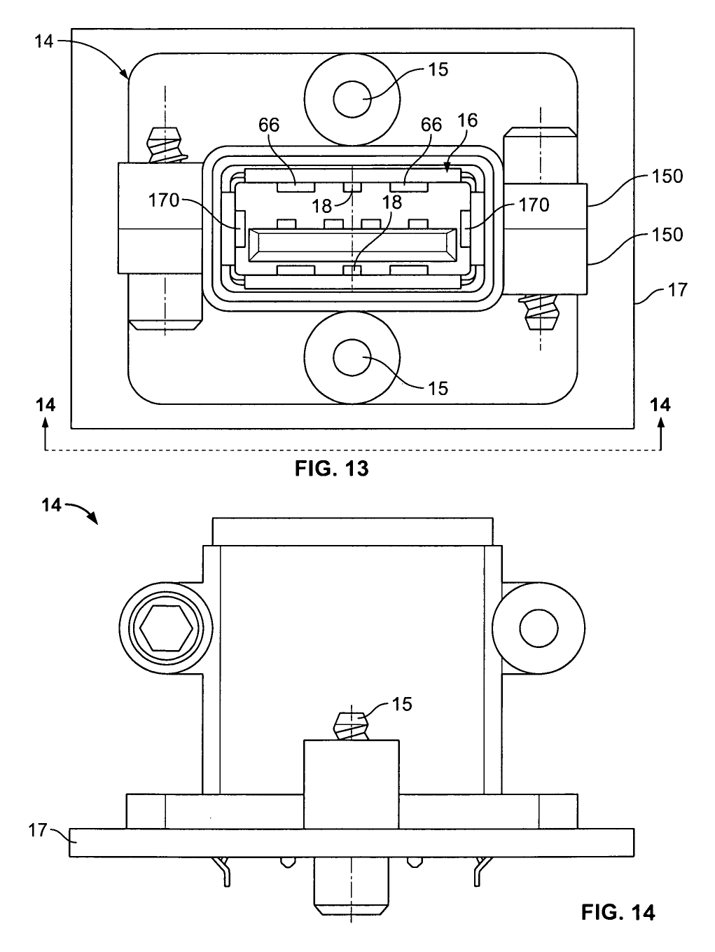

The extended length of the plug sheath 32 in comparison to typical USB plug sheaths is not necessary, but it allows the fore opening 110 to reach farther down the plug sheath 32 (towards the boot 100) and, thus, significantly allows the supporting structure 18 to exert greater moment force against the plug 12 to restrict or damp movement of the plug 12 relative to the receptacle 10 than is possible with a shorter inner casing 16. More specifically, as can be seen in FIG. 8, and 12-14, the outer casing 14 provides a larger footprint with respect to the PCB 17, and, as shown in FIGS. 13 and 14, can be mounted to the PCB 17 with screws 15.

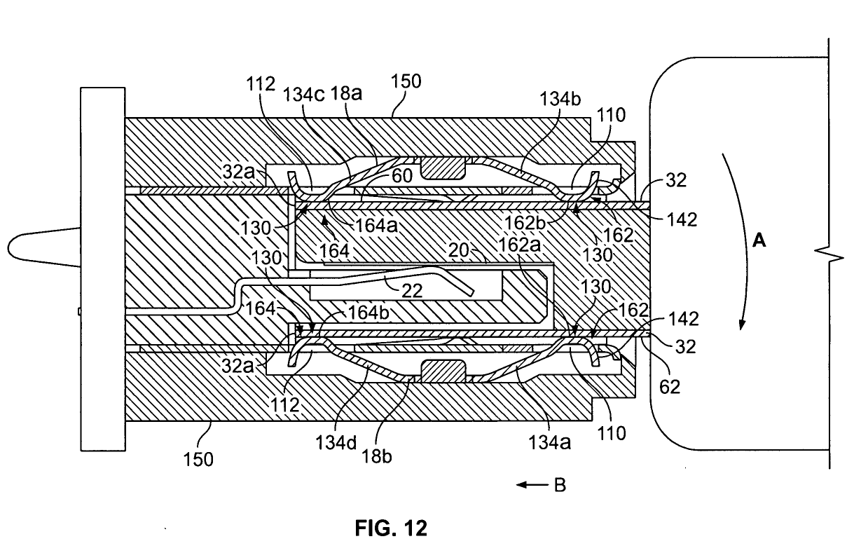

More specifically, in FIGS. 12-14 it can be seen that the outer casing 14 provides a constraint between the inner casing 16 and the PCB 17 which serves to enhance resistance to movement of the inner casing 16 and the PCB 17. As such, the solder connections between the receptacle 10 need resist less force than in comparison to a typical receptacle of the prior art. Furthermore, the outer casing 16 of FIGS. 13 and 14 can have an even greater footprint providing structure for mounting to the PCB 17 via screws 15.

Turning now to the outer casing 14 and the supporting structure 18, in the present forms, the outer casing 14 extends over and around the inner casing 16. By generally enlarging the entire receptacle 10 with the addition of the outer casing 14, in comparison to typical USB receptacles, less deflection of the receptacle 10 relative to its PCB 17 due to bouncing of the USB plug 12 occurs. This improves the life of the solder connections between the receptacle 10 and PCB 17 in comparison to typical USB receptacles and associated PCBs.

The outer casing 14 principally serves to retain and mount the supporting structure 18. In an embodiment, the supporting structure 18 includes bias structures in the form of two dual-leaf springs 18a and 18b mounted within the receptacle 10. To accommodate the dual-leaf springs 18a and 18b and deflection thereof, the outer casing 14 includes recesses 120 positioned out-board of and facing the side portions 16a of the inner casing 16. Located within and extending into each recess 120 is a mount 122 for retaining and positioning one of the dual-leaf springs 18a, 18b. In other forms, the supporting structure 18 may be one or more single leaf springs, bias members, spring arms, elastomers, gel-based structures, or another means; additionally, supporting structure 18 may be disposed on the plug 12.

In the present form, the mount 122 is simply a cylindrical post, and each of the dual leaf-springs 18a, 18b includes a bore 124 through which the post 122 is received. When the receptacle 10 is constructed, the dual-leaf springs 18a, 18b are retained on the post 122 by packaging constraints such that direct securement between the post 122 and dual-leaf springs 18a, 18b is not necessary, though, alternatively, screws may be used or the post 122 may be hot-swaged or insert molded around the bore 124 to retain the dual-leaf spring 18a, 18b thereon.

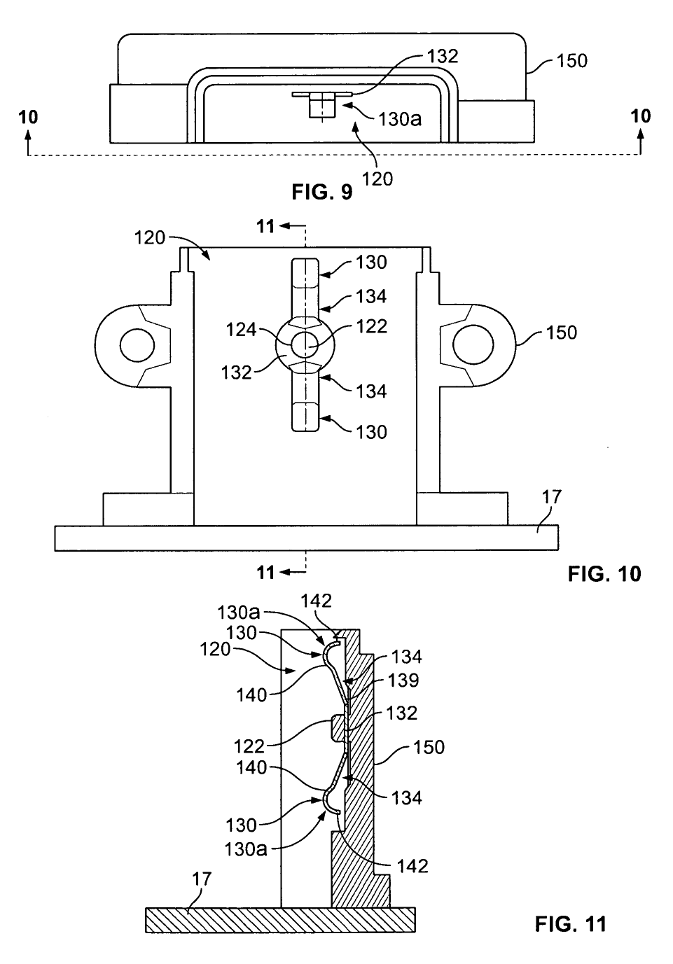

Focusing on FIGS. 9-11 depicting the receptacle 10 having the plug 12 removed therefrom, each dual-leaf spring 18a, 18b has an elbow 130 on generally opposite ends 130a thereof. More specifically, the bore 124 is formed in a generally central portion 132 of the dual-leaf spring 18a, 18b. Extending from the central portion 132 are two leaf arms 134, each angled inwardly with respect to the receptacle axis 78 and towards the inner casing 16. Each leaf arm 134 includes the ends 130a and elbows 130 thereof.

The leaf arms 134 and elbows 130 thereof cooperate with the inner casing fore and aft openings 110 and 112. In comparison to the leaf spring retainers 66, the dual-leaf springs 18a, 18b of the supporting structure 18 are generally larger, more robust, and have a higher spring constant. The leaf arms 134 include a first portion 139 joined contiguous and formed integral with, and angled inwardly from, the central portion 132, a second portion 140joined contiguous and formed integral with the first portion 139 and curved from, or angled inwardly to a greater degree than, the leaf arm first portion 139. The second portion 140 is contiguous with a third portion 142 that curves (or angles outwardly from the second portion 140), the second and third portions 140, 142 defining the elbow 130. The elbows 130, in the assembled receptacle 10, extend through the fore and aft openings 110, 112, so as to contact the plug 12 when received in the receptacle 10.

With reference to FIG. 12, as the plug 12 is inserted in direction B, the plug sheath leading edge 32a contacts the third portion 142 of the elbows 130 extending through the fore openings 110. The sheath 32 thus deflects the third portion 142 and the associated leaf arm 134 outwardly. Continuing the insertion of the plug, the plug sheath leading edge 32a next contacts the second portion 140 of the elbow 130 extending through the aft opening 112, this deflecting the second portion 140 and its associated leaf arm 134 outwardly.

The natural bias of the two dual-leaf springs 18a, 18b serves to press inwardly on each side of the plug sheath 32. As a result, the supporting structure 18 including the dual-leaf springs 18a, 18b resists movement of the plug 12 within the receptacle 10 and damps vibrational movement of the plug 12 therewithin. Accordingly, wear between the leads 20 and 22 is significantly reduced, extending the life of the receptacle 10 and plug 12, and significantly reducing intermittent electrical disconnect between the leads 20, 22.

Referring to FIG. 1, the receptacle 10 with the plug 12 inserted therein can be seen. Opposite sides 60 and 62 of the sheath 32 are shown with the dual-leaf springs 18a, 18b contacting each side 60, 62 in fore and aft positions 162 and 164. Thus, the dual-leaf springs 18a, 18b cooperate as counter-balances. Where the plug 12 is deflected in direction A, for example, the plug 12 would normally (i.e., in the absence of the supporting structure 18) tend to rotate with the retainers elbow 94 (in the openings 64) and, in the present, such retainer elbows 94 and openings 64 generally provide a would-be pivot point or region.

With the supporting structure 18, such rotation is opposed and counteracted. Confronted with a vibrational force that would tend to deflect the plug 12 in the direction A, one leaf spring arm 134a in a fore position 162a is compressed to exert a greater force, while a leaf spring arm 134b in the other fore position 162b simultaneously relaxes somewhat to reduce the force it exerts on the plug 12. Again simultaneously, a leaf spring arm 134c in aft position 164a is compressed, thereby increasing its force, while a leaf spring arm 134d in aft position 164b simultaneously relaxes and decreases the force exerted on the plug 12. In this manner, the leaf spring arms 134a, 134b, 134c, and 134d cooperate to automatically and dynamically react to balance their sum force to maintain the plug 12 in the proper position, thus reducing wear on the leads 20, 22.

Each of the leaf spring arms 134 acts in concert with at least two of the other leaf spring arms 134 in a counter-balancing manner. As described above, the leaf spring arms 134a and 134b dynamically balance the forces they exert when the plug 12 is deflected and the spring arms 134c and 134d act similarly. However, it should also be noted that, for the above example of deflection in the direction A, leaf spring arm 134a and leaf spring arm 134d serve to increase force in opposite directions, though around the pivot point provided by the retainers 66. Also, leaf spring arm 134b and leaf spring arm 134c decrease their force around the pivot point provided by the retainers 66. In one form, it is possible to use a single dual-leaf spring 18a, 18b, though the preferred form of this aspect of the invention is for the pair of dual-leaf springs 18a, 18b to be used, as shown and described.

It should also be noted that the dual-leaf springs 18a, 18b may be non-linear springs (non-linear spring constants) so that the dual-leaf springs 18a, 18b provide a bias force in excess of a linear increase in comparison to the amount the leaf arms 134 are deflected. For instance, movement and force applied in response thereto for a leaf arm 134 with a linear spring constant would be dictated by the equation force=deflection*k, where k is a constant. Accordingly, a 0.1 mm deflection would result in a certain force being exerted, while a 0.2 mm deflection would result in double the force being exerted. For a leaf arm 134 with a non-linear spring constant, the equation would be force=deflection*E, where E is a non-linear factor or equation so that a 0.1 mm deflection would generate a certain force X, while a 0.2 mm deflection would result in a force greater than 2X.

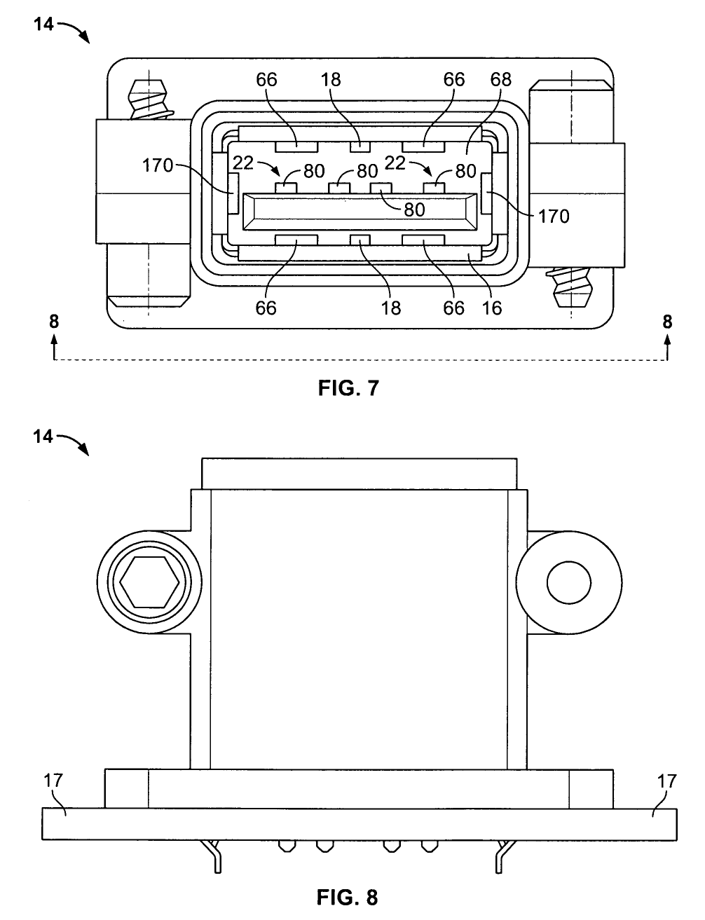

In the present form, the outer casing 14 includes first and second shell halves 150. The shell halves 150 are preferably identical so that assembly components and tooling for manufacturing the halves 150 are minimized. The halves 150 may be secured around the inner casing 16 in any known fashion, including using screws, as shown in FIG. 7, or glueing, or heat sealing, snap connections, as mere examples.

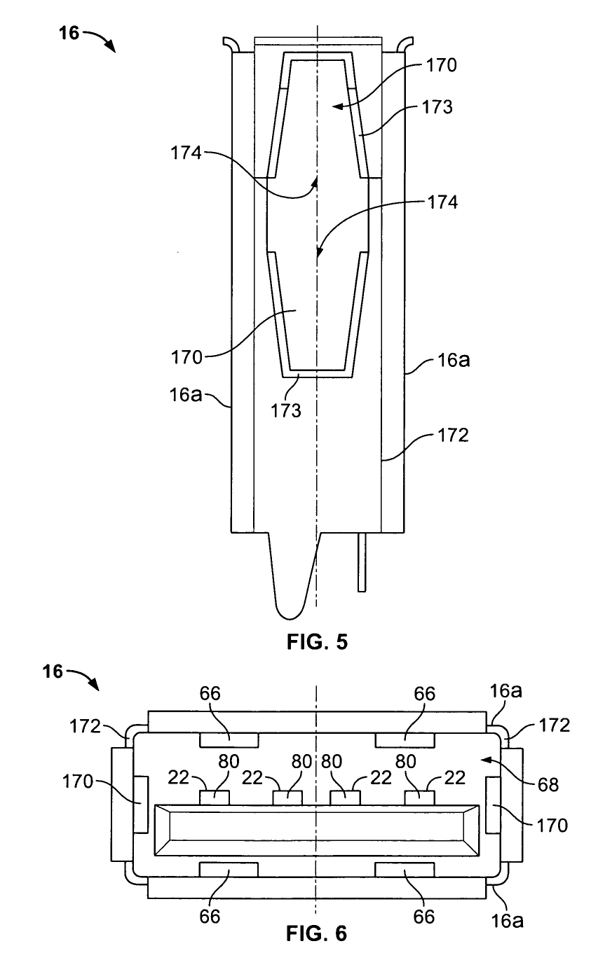

Turning to FIGS. 5 and 6, an additional aspect of the receptacle inner casing 16 is shown. In this form, the inner casing 16 includes supporting structure in the form bias structures, specifically, spring fingers 170 positioned on sides 172 thereof, the sides 172 being aligned with the minor dimension 36 of the plug 12 and extending between sides 16a of the inner casing 16. The casing 14 has openings 173 cut into the sides 172 (such as by stamping) to define the spring fingers 170, a pair of which are formed on each of the minor dimension sides 172. Each of the spring fingers 170 is generally tab-shaped and has a natural position that is deflected inwardly. The spring fingers 170 have a base portion 174 for connecting with the inner casing 16, the base portions 174 of the spring fingers 170 for a given side 172 somewhat proximal to each other so that the spring fingers 170 extend away from each other. In this manner, the inner casing 16 includes four such spring fingers 170 (see FIG. 6) acting in the same manner as the leaf arms 134 to dynamically balance the sum of forces therefrom, and to counteract vibration upon the plug 12.

Within the scope of the invention, the supporting structure 18 are described as operating with a standard USB plug. However, in forms within the scope of the invention, supporting structure may include interlocking structure or clamps, for instance, located either on or cooperating between the plug and the receptacle to retain the plug within the receptacle and to damp or impede or eliminate vibration forces between the plug and the receptacle and, specifically, between the leads of the plug and receptacle.

While the invention has been described with respect to specific examples including presently preferred modes of carrying out the invention, those skilled in the art will appreciate that there are numerous variations and permutations of the above described systems and techniques that fall within the spirit and scope of the invention as set forth in the appended claims.

What is claimed is:

1. A universal serial bus receptacle comprising:
cantilever retaining arms having at least a portion receivable within openings of a universal serial bus plug when received within the receptacle, the retaining arms and plug openings assisting in retaining the plug in the receptacle; and
supporting structure for contacting a universal serial bus plug when received within the receptacle, the supporting structure providing bias to oppose deflection of the plug within the receptacle.

2. The receptacle of claim 1 wherein the supporting structure includes a plurality of bias structures that cooperate to balance force applied by each bias structure against the plug within the receptacle.

3. The receptacle of claim 2 wherein the supporting structure includes a first bias structure and a second bias structure, each of the first and second bias structures providing respective forces in opposite directions.

4. The receptacle of claim 3 wherein the first bias structure provides a force around a pivot point in a first direction, while the second bias structure provides a force around the pivot point in a second direction opposite the first direction.

5. The receptacle of claim 4 wherein the first and second bias structures are formed integral as a dual-leaf spring.

6. The receptacle of claim 3 wherein, when the plug is received within the receptacle, the first bias structure contacts the plug in an aft position, and a second bias structure contacting the plug in a fore position.

7. The receptacle of claim 3 wherein the supporting structure further includes a third bias structure for contacting the plug in a second aft position, and a fourth bias structure for contacting the plug in a second fore position, wherein each of the bias structures dynamically balance the sum of forces therefrom around the pivot point.

8. The receptacle of claim 7 wherein the bias structures are formed as a pair of dual-leaf springs.

9. The receptacle of claim 1 further including an inner casing for receiving the plug therein, the inner casing including a set of openings for the supporting structure, the supporting structure including at least two bias structures providing forces in opposite directions to oppose deflection of the plug received within the inner casing, the bias structures at least partially passing through the inner casing openings to contact the plug received therewithin.

10. The receptacle of claim 9 wherein the set of openings includes first and second aft openings in opposed sides of the inner casing, and first and second fore openings in the opposed sides of the inner casing, each of the fore and aft openings receiving bias structure to permit the bias structures to contact the plug when received within the inner casing.

11. The receptacle of claim 9 further including an outer casing for mounting and positioning the bias structures with at least a portion of the bias structures extending through the inner casing openings to contact and provide bias to the plug when received therein.

12. The receptacle of claim 11 wherein the bias structures provide a counter-balanced force with respect to each other against the plug when received therein.

13. The receptacle of claim 1 wherein the supporting structure includes bias structures positioned to contact and provide bias force in opposite directions around a pivot point generally defined by the retaining arms and plug openings.

14. The receptacle of claim 1 wherein the supporting structure includes a first dual-leaf spring adapted to contact a first side of the plug when received in the receptacle in fore and aft positions, and a second dual-leaf spring adapted to contact a second side of the plug in fore and aft positions.

15. The receptacle of claim 1 further including an inner casing for receiving the plug therein, the cantilever arms formed integral with the inner casing, and an outer casing mounted around the inner casing, the outer casing providing a mount for the supporting structure.

16. The receptacle of claim 15 wherein the inner casing includes openings to permit the support structure to pass at least partially therethrough to contact the plug when received within the receptacle.

17. The receptacle of claim 1 wherein the deflection is the result of vibrational forces, and the supporting structure opposes the vibrational forces.

18. The receptacle of claim 17 wherein the receptacle is mountable in an automobile, and the supporting structure opposes vibrational forces due to operation of the automobile.

19. The receptacle of claim 1 further including an inner casing for receiving the plug therein, and an outer casing maintaining the supporting structure in contact with the plug when received within the receptacle, the outer casing serving to reduce vibrational stress on solder joints between the receptacle and a structure to which the receptacle is mounted.

20. The receptacle of claim 1 wherein the supporting structure includes first bias structures adapted to contact major dimension sides of the plug, and second bias structures for contacting minor dimension sides of the plug when received therein.

21. The receptacle of claim 20 further including an inner casing formed integral with the second bias structures for contacting the minor dimension sides of the plug when received therein.

22. The receptacle of claim 21 wherein the retaining arms are formed integral with the inner casing and with the bias structures for contacting the minor dimension sides of the plug when received therein.

23. An assembly for connecting electrical components, the assembly including:
a plug having electrical leads;
a receptacle for receiving the plug, the receptacle having electrical leads in electrical communication with the plug leads when the plug is received within the receptacle;
retaining structure for restraining withdrawal of the plug from the receptacle; and
supporting structure providing bias between the plug and receptacle to oppose deflection of the plug within the receptacle.

24. The assembly of claim 23 wherein the supporting structure includes a plurality of bias structures providing counter-balance bias forces between the plug and receptacle to resist deflection of the plug within the receptacle due to vibration forces upon the assembly.
